(19) United States
(12) Patent Application Publication
(10) Pub. No.: US 2025/0092795 A1
(43) Pub. Date: Mar. 20, 2025

(54) VANE ACTUATING ARM FOR A GAS TURBINE, TURBOMACHINE HAVING THE VANE ACTUATING ARM, AND METHOD FOR MOUNTING A VANE ACTUATING ARM FOR A TURBOMACHINE

(71) Applicant: MTU Aero Engines AG, Muenchen (DE)

(72) Inventors: Florian NEUBERGER, Dorfen (DE); Martin PERNLEITNER, Dachau (DE); David STRUNCK, Munich (DE); Franz-Josef ERTL, Munich (DE); Marcin KOZDRAS, Krosno (PL)

(21) Appl. No.: 18/959,292

(22) Filed: Nov. 25, 2024

(30) Foreign Application Priority Data
Dec. 13, 2023 (EP) 23216419.4

(51) Int. Cl. F01D 17/12

(52) U.S. Cl. CPC F01D 17/12; F05D 2260/50

(57) ABSTRACT

Avane actuating arm (10) for a turbomachine, the vane actuating arm (10) including two legs (12) which are pivotable relative to each between at least one open position and a closed position and form a clamping device having at least one clamping surface (14) on each of the legs (12). In the closed position, a vane stem (20) provided for varying the pitch of a stator vane of the turbomachine can be frictionally held between the two legs (12) via the two clamping surfaces (14), forming a clamping connection (16). Each of the legs (12) has an opening (50), the openings (50) overlapping each other in the closed position such that a through-bolt connectable to an actuating element of the turbomachine for controlling an angular position of the vane stem (20) can be passed through the openings (50).

This claims the benefit of European Patent Application EP23216419.4, filed on Dec. 13, 2023 which is hereby incorporated by reference herein.

The invention relates to a vane actuating arm for a turbomachine, in particular for an aircraft gas turbine, a turbomachine having the vane actuating arm, as well as a method for mounting a vane actuating arm.

### BACKGROUND

Turbomachines, in particular gas turbines or aircraft gas turbine, have both stator vanes and rotor blades. The stator vanes are mounted on stator vane rings, while the rotor blades are mounted on rotor blade rings. Turbomachines often have several of these vane and blade rings arranged as successive stages along a direction of a shaft of the respective turbomachine. The function of the rotor blades is to provide the power for passing a gas through the turbomachine. For this purpose, the rotor blades are mounted on a rotor of the turbomachine and rotate during operation. In contrast, the stator vanes are mounted on a stator and are static during operation. The function of the stator vanes is to suitably guide the flow through the turbomachine so as to deliver it at a predetermined angle to the rotor blades. A pitch angle of the stator vanes can be varied depending on a current operating state of the turbomachine. For this reason, the stator vanes are rotatably mounted in the turbomachine. Rotation of the stator vane about the pitch change axis is accomplished by means of lever devices disposed on a vane stem of the stator vanes. This vane stem is disposed at a radially outer end of the variable stator vane (i.e., at an end of the stator vane facing away from the rotor shaft of the turbomachine) and outside the area of the turbomachine through which the flow passes. The stem of the variable stator vane is arranged to extend within the turbomachine through a lead-through from the first area, through which the flow passes, into a second area that extends radially around the first area and accommodates the lever devices and the ends of the stator vanes. The lever devices have to be disposed on the respective vane stems in a manner that allows a force to be transferred from the lever devices to the stator vanes.

In the prior art, usually a lever arm for actuating the stator vane (i.e., the vane actuating arm) is placed on the vane stem and fixed thereto by means of a nut. The nut is typically secured against accidental unscrewing by a cotter pin. Furthermore, the vane stem has a flattened region or chamfer or groove with which the lever arm is engaged and which allows the vane actuating arm to be prevented from rotation relative to the stator vane by means of a form fit. At its other end, the vane actuating arm is connected to an actuating element, which is configured as a circular actuating ring surrounding the turbomachine in the second area. By means of the actuating ring, all stator vanes of a stator vane ring that are connected to the actuating ring can be actuated together.

European Patent Application Publication No. EP 3 524 781 A1, for example, discloses a connecting device for a variable stator vane of a gas turbine, which includes a vane stem connected to the respective stator vane and a lever element connected to the vane stem, the lever element and the vane stem being jointly movable about an axis of rotation of the vane stem. It is provided that the lever element and the vane stem are aligned with each other by a positioning element, the positioning element being received in a vane stem receptacle and a lever receptacle.

Further, European Patent Application Publication No. EP 3 683 408 A2, for example, discloses a lever arm assembly for a gas turbine engine, which includes a vane arm having a first end, a second end opposite the first end, and an aperture proximate the second end, the aperture being defined by an aperture wall. A vane stem extending through the aperture of the vane arm is retained by a mechanical fastener in the longitudinal direction of the vane stem at a position of the vane arm. An impedance clip partially enclosing a portion of the second end of the vane arm is provided to provide redundant position retention of the vane arm in the longitudinal direction of the vane stem.

Furthermore, U.S. Pat. No. 4,307,994 A discloses a turbine vane adjustment and actuation system for calibrating the nozzle/throat width dimensions between adjacent angularly adjustable nozzle vanes in a nozzle vane ring assembly and for controlling conjoint rotation of the individual vanes following calibration thereof with a vane stem.

### SUMMARY OF THE INVENTION

However, there is a need to make turbomachines smaller in size in order to reduce a radius of the entire turbomachine and to reduce the weight thereof. It is also important to reduce the maintenance requirements of the turbomachine and to reduce the number of parts required for the turbomachine.

It is an object of the present invention to provide an improved vane actuating arm that is easy to install and makes it possible to reduce the space requirements of the overall lever device.

The present invention provides a vane actuating arm for a turbomachine, in particular a gas turbine or a thermal turbomachine, the vane actuating arm including two legs which are pivotable relative to each other, in particular about a pivot axis, between at least one open position and a closed position and form a clamping device having at least one clamping surface on each of the legs, wherein in the closed position, a vane stem provided for varying the pitch of a stator vane of the turbomachine can be frictionally held between the two legs via the two clamping surfaces, forming a clamping connection. The two clamping surfaces may be of any shape. For instance, the clamping surfaces may be substantially flat surfaces. In this context, “forming a clamping connection” means that in the closed position of the vane actuating arm, a pressing force is produced which is exerted on the vane stem by the legs in the closed position so as to frictionally and/or form-fittingly hold the same. This means that in the closed position, the vane actuating arm can hold the vane stem in a non-rotatable fashion, i.e., such that it is secured against rotation. It should be noted that, unless otherwise stated, the term “closed position” as used herein includes that the vane actuating arm is disposed or mounted on the vane stem. It should also be noted, especially with regard to the open and closed positions, that the vane stem is held by the clamping connection only in the closed position. In the open position, no holding of the vane stem takes place.

Furthermore, each of the legs has a fastening portion configured, for example, as an opening or a projection, in particular at an end of the leg opposite the pivot axis. This fastening portion is adapted to be releasably, frictionally and/or form-fittingly connected to an actuating element of the turbomachine for controlling an angular position of the vane stem. In accordance with a preferred embodiment, the fastening portions may be configured as openings defined or formed by walls of the leg, the openings of the two legs overlapping each other, in particular completely, in the closed position such that a through-bolt connectable to an actuating element of the turbomachine for controlling an angular position of the vane stem can be passed through the openings. Advantageously, the openings are circular openings having a predetermined diameter. However, the openings may have any other shape such as, for example, an oval shape or the shape of an elongated slot. The actuating element is in particular a circular actuating ring of, for example, rectangular or polygonal cross section, which surrounds the axis of flow and serves to actuate, or vary the pitch of, all stator vanes of one stator vane ring simultaneously. The vane stem is typically arranged radially perpendicular to a main shaft of the turbomachine. However, the vane stem may also be at any other suitable angle to the main shaft. In order to vary the pitch of the stator vane, the vane stem is rotatable about an axis of rotation of the vane stem, the rotation of the vane stem being controllable by means of the installed vane actuating arm in the closed position. By means of the through-bolt connection, the vane actuating arm can be fixed relative to the actuating ring.

The vane actuating arm has the advantage that it is held on the vane stem by means of the clamping connection. In order to mount the vane actuating arm on the vane stem, the two openings of the two legs of the vane actuating arm are positioned one above the other and fixed relative to the actuating ring by means of the through-bolt. Therefore, no nut is needed on the vane stem, which reduces the number of parts and the installed height or length of the vane stem. This results in reduced space requirements for the lever device, making it possible to reduce the overall radius of the stator vane ring. Since no cotter pin is needed on the vane stem to secure a retaining nut against accidental unscrewing, it is possible to further reduce the number of required parts, to simplify a lever device for actuating stator vanes and the mounting thereof, and to reduce the associated costs. Moreover, due to the reduced number of installed parts, reliability can be increased and the design can be simplified.

The invention encompasses further advantageous embodiments, which provide other additional advantages.

Another advantageous embodiment provides that in the open position, the vane actuating arm is attachable to or mountable on the vane stem of the stator vane. This means that, when in the open position, the vane actuating arm can be brought to the intended position on the vane stem since, in the open position, the vane actuating arm has a sufficient opening width, i.e., a sufficient opening angle, so that the clamping connection can receive or release the vane stem and the vane stem can be removed from the clamping connection. This may mean, for example, that the vane actuating arm can be removed from the vane stem in the axial direction thereof or in a direction perpendicular to the pivot axis and away therefrom. Thus, this embodiment has the advantage that, in the open position, the vane actuating arm can be easily mounted on the vane stem.

In accordance with a preferred embodiment of the invention, the pivot axis and the clamping surface may each be disposed on one half of each leg, and the fastening portion may be disposed on an opposite half of the respective leg. In other words, a distance from the fastening portion to the pivot axis, as viewed in the longitudinal direction of the leg, may be greater than the distance from the clamping portion to the pivot axis. In this way, advantageous leverage ratios can be achieved for the application of a clamping force.

A further advantageous embodiment provides that a clamping surface on a first leg of the two legs and a clamping surface on a second leg of the two legs face each other, the first leg and the second leg being different legs, and these two clamping surfaces facing the pivot axis. This means that the two clamping surfaces each have a normal vector directed, for example, from the middle of the respective clamping surface at least partially in the direction of the pivot axis. That is to say, the two clamping surfaces of the two legs form an angle that opens toward the pivot axis. This design has the advantage that the vane stem is pressed toward the pivot axis by a pressing force on the clamping surfaces, and thus, this design can be made backlash-free. This makes it possible to further improve the vane actuating arm and to simplify assembly. This can also simplify the manufacture of the vane actuating arm since the allowable tolerances are greater than in the case where the clamping surfaces are parallel.

It should also be noted that for each clamping surface, the axis of rotation of the vane stem should be parallel to a direction that lies in this clamping surface so as not to produce any force on the vane stem in the direction of the vane stem in the closed position.

Another advantageous embodiment provides that the vane actuating arm is formed as a single piece, and that a pivotability of the vane actuating arm is achieved by means of at least one flexure bearing. The term “flexure bearing” refers to portions of a component which allow relative movement (rotation) between two rigid portions through bending. The function of a joint is here achieved by a portion that has a lower bending stiffness than two adjacent portions. The reduced bending stiffness can be brought about by a local reduction in cross section. A flexure bearing is comparable to a conventional pivot joint having a limited pivot range. The formation of a flexure bearing can provide an economical alternative to a real joint because it requires fewer components. Moreover, frictionless relative movement is enabled between the left leg and the right leg, without any particles being produced by friction in the flexure bearing. A reduced long-term functional reliability of the flexure bearing compared to a conventional joint is not critical since the vane actuating arm is moved only during assembly and disassembly. Thus, this design has the advantage of requiring fewer components and facilitating assembly while providing the same functionality.

A further advantageous embodiment provides that in the closed position, a common central axis of the two openings is parallel to an axis of rotation of the vane stem. This means that in the closed position, the two openings allow a through-bolt to be passed therethrough, and an axis of the through-bolt and the pass-through direction are substantially parallel to an axis of rotation of the vane stem. In this context, it should be noted that due to the radial symmetry of the stator vane ring, a small angular deviation of the through-bolt may occur during movement of the actuating ring, so that it may possibly be necessary to rotatably mount or support the through-bolt on the actuating ring and in the opening, respectively, and to provide for tolerances that allow such movement.

Another advantageous embodiment provides that in the closed position, a longitudinal direction of each leg, i.e., a direction from the pivot axis to the respective opening in the leg, is substantially perpendicular to the axis of rotation of the vane stem. In this way, it is achieved that the vane actuating arm is mounted substantially perpendicular to the vane stem, thus enabling optimal force transfer.

A further advantageous embodiment provides that, for each leg, a distance (d1) from the pivot axis to the respective clamping surface is smaller than a distance (d2) from the pivot axis to the respective opening and/or that a distance (d1) from the pivot axis to the respective clamping surface is smaller than a distance (d3) from the respective clamping surface to the respective opening. This means that in the closed position, when the vane actuating arm is mounted, the vane stem is located between the pivot axis and the openings or that in the closed position, when the vane actuating arm is mounted, the pivot axis is located between the vane stem and the opening. Furthermore, the distance between the clamping surface and the vane stem is smaller than the distance from the pivot axis or the vane stem to one of the openings, so that a lever arm is configured such that a small force on the legs at the position of the opening can produce a large force on the clamping surfaces at the position of the vane stem. This means also that an arrangement where the vane stem is closer to the openings than to the pivot axis would be unfavorable and, therefore, should be avoided.

Thus, this design has the advantage that the configuration of the lever arm simplifies assembly, and that a small force on the openings can produce a large holding force or pressing force on the vane stem. Due to the small force on the openings, friction at the location of the openings is reduced, and the service life of the vane actuating arm is increased.

Another advantageous embodiment provides that at least one of the clamping surfaces has a receiving element for form-fitting connection to a connecting device provided on the vane stem, i.e., a groove, an indentation, a receiving space, or a projection. In the closed position of the vane actuating arm, the receiving element of the at least one clamping surface is in engagement with the connecting device provided on the vane stem. This means that the vane stem may have a shape that may include a plurality of clamping surfaces forming an angle with respect to each other, so that a higher transfer of force from the vane actuating arm to the vane stem becomes possible. It should be noted that with such a configuration of the vane stem, the clamping surface may be configured correspondingly to enable a form-fitting connection between the clamping surfaces and the vane stem. This design has the advantage that higher forces can be transferred between the vane actuating arm and the vane stem, and that the vane stem can be non-rotatably held in the clamping connection.

A further advantageous embodiment of the invention relates to a turbomachine having a vane actuating arm according to any of the preceding claims, wherein at least one stator vane is mounted so as to radially bound a flow duct of the turbomachine, and wherein the pitch of the stator vane can be varied by means of the vane actuating arm, which is connected to an actuating ring of the turbomachine. In this way, it is possible to achieve the aforementioned advantages of the further embodiments and, in particular, a reduced diameter of the turbomachine as well as a smaller number of parts of the turbomachine.

Another advantageous embodiment of the invention relates to a method for mounting a vane actuating arm for a turbomachine, the vane actuating arm including two legs which are pivotable relative to each other between at least one open position and a closed position and form a clamping device having at least one clamping surface on each of the legs, each of the legs having an opening, wherein in the open position, the vane actuating arm is placed on a vane stem of a variable stator vane of the turbomachine, which vane stem is provided for varying the pitch of the variable stator vane, and the vane actuating arm is brought into the closed position, in which the legs form a clamping connection by means of the two clamping surfaces, the clamping connection frictionally holding the vane stem between the two legs via the two clamping surfaces, and in which the two openings of the legs overlap each other so as to receive therethrough a through-bolt which is connected to an actuating element of the turbomachine for controlling an angular position of the vane stem.

This means that the method provides a simplified method for mounting the inventive vane actuating arm, and that this method is easier to perform, and thus, is more economical than methods known heretofore.

### BRIEF DESCRIPTION OF THE DRAWINGS

Other features of the invention will be apparent from the claims and the exemplary embodiments. The features and feature combinations mentioned in the preceding description as well as the feature combinations mentioned below in the examples may be used not only in the specified combinations, but also in other combinations or in isolation, without departing from the scope of the invention. Thus, embodiments of the invention that are not explicitly shown and described in the examples are also considered to be included and disclosed herein. Embodiments and combinations of features that do not have all of the features of an originally formulated claim should also be considered as being disclosed. In the figures, like parts are identified by the same reference numerals. In the drawing,

FIG. 1 is a perspective view of a vane actuating arm as known in the prior art;

FIG. 2A is a perspective view showing a vane actuating arm according to an exemplary embodiment of the invention in a closed position;

FIG. 2B is a perspective view showing a vane actuating arm according to an exemplary embodiment of the invention in an open position;

FIG. 2C is a top view showing a vane actuating arm according to an exemplary embodiment of the invention in the closed position;

FIG. 3 is a perspective view showing a vane actuating arm according to another exemplary embodiment of the invention in a closed position;

FIG. 4A is a perspective view showing a vane actuating arm according to a further exemplary embodiment of the invention in a closed position;

FIG. 4B is a perspective view showing a vane actuating arm according to an exemplary embodiment of the invention in an open position;

FIG. 4C is a top view showing a vane actuating arm according to an exemplary embodiment of the invention in the closed position;

FIG. 5A is a perspective view of a vane actuating arm; and

FIG. 5B is another perspective view of a vane actuating arm.

### DETAILED DESCRIPTION

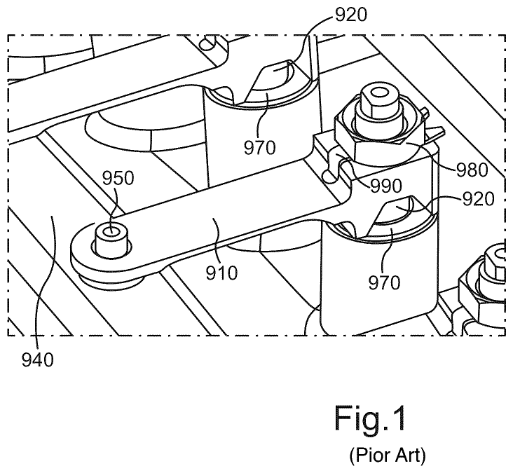

FIG. 1 shows a perspective view of a vane actuating arm as known in the prior art. This perspective view shows a vane actuating arm 910 of a stator vane ring of a turbomachine, the vane actuating arm 910 being mounted on vane stem 920. Vane stem 920 has a chamfer or flattened region or groove with which engages a projection of vane actuating arm 910. Vane actuating arm 910 is secured against falling off by a nut 980, which in turn is secured by a cotter pin 990 against accidental unscrewing. The end of vane actuating arm 910 opposite the vane stem is provided with an opening which accommodates a through-bolt 950. Through-bolt 950, in turn, is attached to an actuating ring 940, by which all stator vanes of the illustrated stator vane ring of the illustrated stage of the turbomachine can be actuated together. Vane stem 920 is held in a lead-through 970 or bearing and extends inside of the turbomachine to hold or form a stator vane therein. Vane stem 920 may be formed integrally with the stator vane.

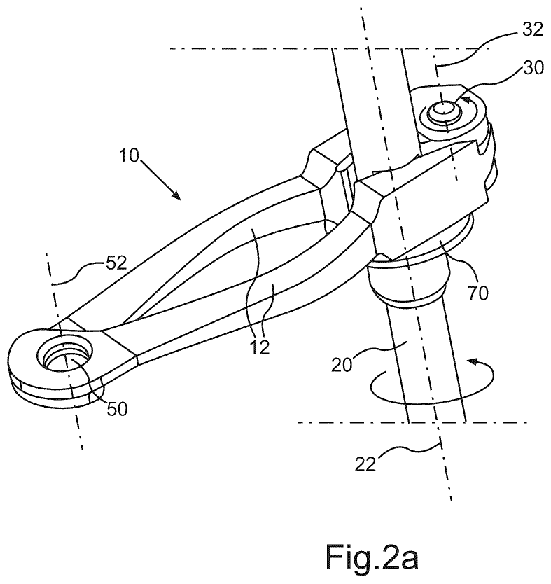

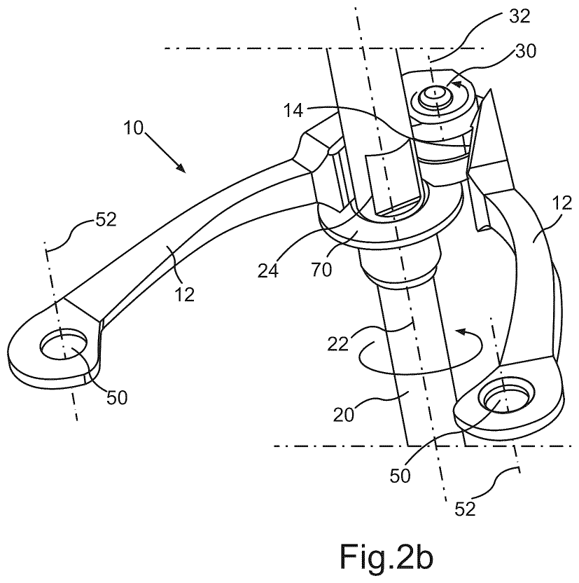

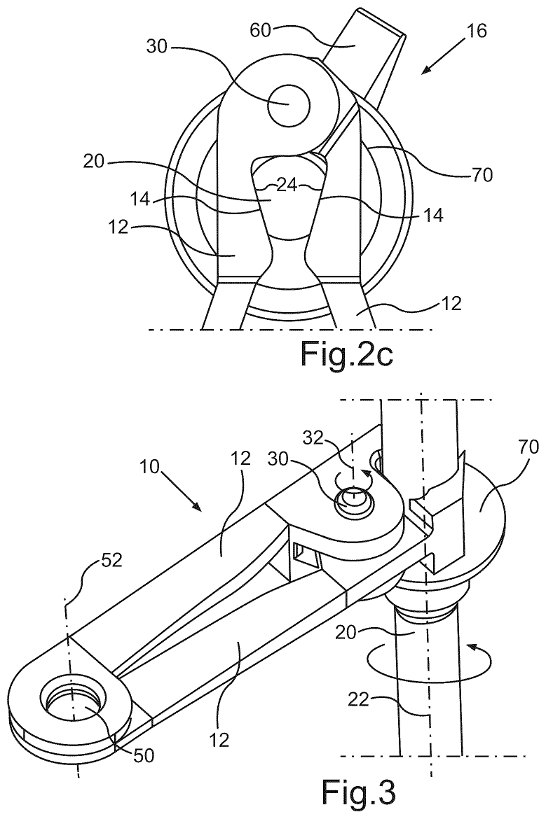

FIG. 2A is a perspective view showing a vane actuating arm 10 according to an exemplary embodiment of the invention in a closed position, with the vane stem mounted. Vane actuating arm 10 has two legs 12, which are pivotable relative to each other between at least one open position and a closed position by means of a pivot axis 32. The two legs form a clamping device to hold a vane stem 20 having an axis of rotation 22. The clamping device has at least one clamping surface 14 on each of legs 12 (see e.g. FIG. 2). In the closed position according to FIG. 2A, a vane stem 20 provided for varying the pitch of a stator vane of the turbomachine between the two legs 12 via the two clamping surfaces 14, forming a clamping connection 16, movement of openings 50 to exert a large force by means of clamping surfaces 14, which, in the closed position with vane actuating arm 10 mounted, hold vane stem 20 frictionally and/or form-fittingly, and thus in a non-rotatable fashion, i.e., such that it is secured against rotation. Furthermore, each of legs 12 has an opening 50 at an end of the leg remote from or opposite pivot axis 32, the two openings 50 of the two legs 12 of vane actuating arm 10 overlapping each other in the closed position such that a through-bolt connectable to an actuating element or actuating ring of the turbomachine for controlling an angular position of vane stem 20 about axis of rotation 22 can be passed through openings 50. When the actuating ring is rotated about the shaft of the turbomachine, it moves vane actuating arm 10 via the through-bolt in openings 50, and it can be achieved that all vane stems 20 of the respective stator vanes of the stator vane ring under consideration can be actuated together. FIG. 2A further shows a lead-through 70 which rotatably holds vane actuating arm 10 and which is connectable to a housing of the turbomachine.

FIG. 2B shows vane actuating arm 10 in the open position, exposing to view a groove 24 or clamping surface of vane stem 20. Groove 24 has a width in the direction of axis of rotation 22 along vane stem 20, the width being selected such that in the closed position, vane actuating arm 10 is secured from slipping axially on vane stem 20.

When in the open position, vane actuating arm 10 can be removed from or mounted on vane stem 20. Groove 24 of vane actuating arm 10 and clamping surfaces 14 of the vane actuating arm are configured such that they are in contact with each other over a substantial portion of their surface area in the assembled state or in the closed position of the vane actuating arm, thus preventing rotation of the stem relative to the vane actuating arm.

FIG. 2C shows a top view of vane actuating arm 10 in the closed position, illustrating, in particular, clamping connection 16. It can be seen that in the closed position, clamping surfaces 14 are in contact with grooves 24 over a substantial portion of their surface area. The surfaces do not need to be plane, but may also be curved or may have projections, for example, to enable a higher transfer of force between vane actuating arm 10 and vane stem 20.

At least one of clamping surfaces 14 may have a receiving element for form-fitting connection to a connecting device provided on the vane stem. In the closed position of vane actuating arm 10, the receiving element of the at least one clamping surface 14 may be in engagement with the connecting device provided on vane stem 20.

FIG. 3 presents a perspective view showing a vane actuating arm 10 according to another exemplary embodiment of the invention in a closed position. While in the exemplary embodiment illustrated in FIGS. 2A through 2C, the vane actuating arm is configured in accordance with a first design, where clamping surfaces 14 are located between the pivot axis and the openings, in the exemplary embodiment illustrated in FIG. 3, the vane actuating arm is configured in accordance with a second design, where the pivot axis is located between clamping surfaces 14 and the openings. That is, in the exemplary embodiment illustrated in FIG. 3, the pivot axis is located between openings 50 of legs 12 and clamping surfaces 14, whereas in the exemplary embodiment illustrated in FIGS. 2A through 2C, clamping surfaces 14 are located between pivot axis 32 and openings 50. In both exemplary embodiments, a distance from pivot axis 32 to the respective clamping surfaces 14 is smaller than a distance from the respective opening 50 to the respective clamping surface 14 and/or pivot axis 32.

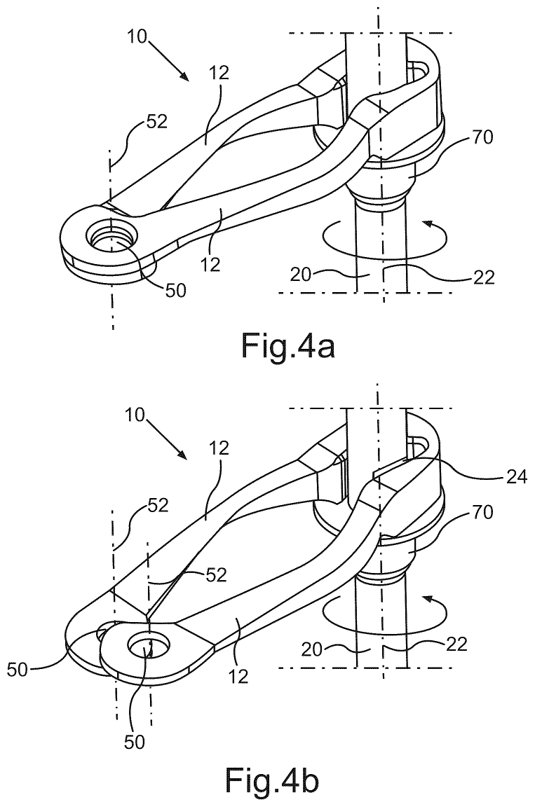

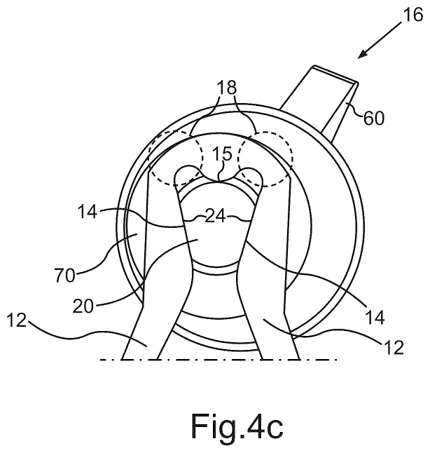

FIG. 4A depicts a view showing a vane actuating arm 10 according to a further exemplary embodiment of the invention in the closed position. In this exemplary embodiment, vane actuating arm 10 is formed as a single piece. A pivotability of vane actuating arm 10, i.e., a pivotability of one leg 12 relative to the other leg 12, is achieved by means of at least one flexure bearing. The term “flexure bearing” refers to a portion of a component that allows relative movement or pivoting or rotation between two rigid portions through bending. The function of a joint is here achieved by a portion that has a lower bending stiffness than two adjacent portions. The reduced bending stiffness is mostly brought about by a local reduction in cross section. A flexure bearing is therefore comparable to a conventional pivot joint having a limited pivot range. Flexure bearings provide an economical alternative to real joints because they have fewer components. A reduced long-term functional reliability is not critical since the vane actuating arm is moved only during assembly. In contrast to roller bearings or ball bearings, flexure bearings enable frictionless relative movement and, therefore, no particles are produced by friction in the joint. In addition, the exemplary embodiment has the advantage that it is formed as a single piece, and thus, the number of parts is reduced, allowing a reduction in costs.

FIG. 4B presents a perspective view showing the vane actuating arm according to the exemplary embodiment of the invention in the open position. As before, a common axis extending through the two openings 50 in the closed position is parallel to an axis of rotation 22 of vane stem 20, and openings 50 overlap each other in the closed position such that a through-bolt connectable to an actuating element or actuating ring of the turbomachine for controlling an angular position of vane stem 20 can be passed through openings 50. However, in the open position, openings 50 do not or only slightly overlap each other. By bringing the two legs 12 from the open to the closed position according to FIG. 4A, a pressing force is exerted on vane stem 20 and on clamping surfaces 14 and grooves 24 of vane stem 20. The pressure force enables a form-fitting connection and allows vane actuating arm 10 to be held non-rotatably relative to vane stem 20.

FIG. 4C depicts a top view showing the vane actuating arm according to the exemplary embodiment of the invention in the closed position, and illustrating, in particular, clamping connection 16 of this exemplary embodiment. In the case of the exemplary embodiment of FIG. 4C, two flexure bearings 18 are disposed between the two legs of vane actuating arm 10, and a contact point 15 or stop is disposed between flexure bearings 18. In the closed position, contact point 15 contacts vane stem 20 to prevent vane actuating arm 10 from slipping relative to vane stem 20 in the closed position. It can further be seen that the two clamping surfaces 14 are in engagement with grooves 24 of vane stem 20. When the two openings 50 of vane actuating arm 10 are moved away from each other by a force on openings 50, the two legs 12 are flexed apart, with the flexure of vane actuating arm 10 being concentrated substantially at the two flexure bearings 18, and vane stem 20 is released. This enables vane actuating arm 10 to be mounted on vane stem 20 and to be removed therefrom, respectively.

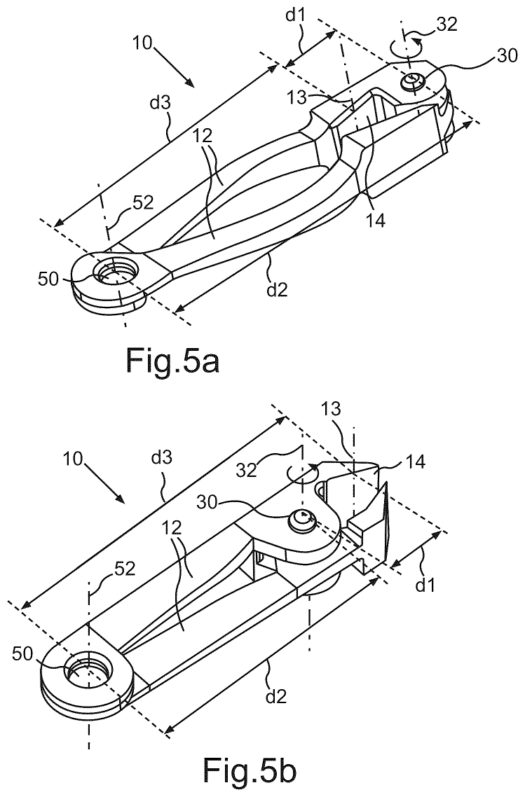

FIG. 5A depicts another perspective view of vane actuating arm 10 according to an exemplary embodiment of the invention, without showing a vane stem 20. In FIG. 5A, a central axis 52 of opening 50 is plotted for purposes of illustration. When vane actuating arm 10 is in the closed position, the two openings 50 of the two legs 12 are positioned one above the other. Furthermore, a centerline 13 of the clamping surface 14 is plotted on one of the legs 12 to enable a clearer illustration. However, the exact position of centerline 13 approximately in the middle of clamping surface 14 is not important, and it should only be noted that centerline 13 is in a plane of clamping surface 14 and parallel to pivot axis 32. A distance between pivot axis 32 and centerline 13 of clamping surface 14 is denoted by d1. Furthermore, a distance between pivot axis 32 and central axis 52 of opening 50 is denoted by d2, and a distance from centerline 13 of clamping surface 14 to central axis 52 of opening 50 is denoted by d3. With the distances labeled in this way, distance d1 is smaller than distance d2 for each leg. In addition, distance d1 is smaller than distance d3. Thus, a lever arm is formed that allows a large force to be exerted via clamping surfaces 14 by a small movement of openings 50, clamping surfaces 14 holding vane stem 20 when vane actuating arm 10 is mounted and in the closed position. Thus, vane actuating arm 10 can be secured more effectively against rotation relative to vane stem 20.

FIG. 5B depicts another perspective view of a vane actuating arm 10 according to a further exemplary embodiment of the invention in the closed position, without showing vane stem 20. In FIG. 5B, a central axis 52 of opening 50 is plotted for purposes of illustration. When vane actuating arm 10 is in the closed position, the two openings 50 of the two legs 12 are positioned one above the other. Furthermore, only one centerline 13 of clamping surface 14 is plotted on one of the legs 12 to enable a clearer illustration. However, the exact position of centerline 13 approximately in the middle of clamping surface 14 is not important, and it should only be noted that centerline 13 is in a plane of clamping surface 14 and parallel to pivot axis 32. As before, a distance between pivot axis 32 and centerline 13 of clamping surface 14 is denoted by d1. Furthermore, a distance between pivot axis 32 and central axis 52 of opening 50 is denoted by d2, and a distance from centerline 13 of clamping surface 14 to central axis 52 of opening 50 is denoted by d3. With the distances labeled in this way, distance d1 is smaller than distance d2 for each leg. In addition, distance d1 is smaller than distance d3. Thus, in this embodiment, too, a lever arm is formed that allows a large force to be exerted by means of clamping surfaces 14 by a small movement of the openings 50, clamping surfaces 14 holding vane stem 20 when vane actuating arm 10 is mounted and in the closed position with. Thus, vane actuating arm 10 can be secured more effectively against rotation relative to vane stem 20.

LIST OF REFERENCE CHARACTERS

| | |
|---|---|
| 10 | vane actuating arm |
| 12 | leg |
| 13 | centerline |
| 14 | clamping surface |
| 15 | contact point |
| 16 | clamping connection |
| 18 | flexure bearing |
| 20 | vane stem |
| 22 | axis of rotation |
| 24 | groove |
| 32 | pivot axis |
| 50 | opening |
| 52 | central axis |
| 70 | lead-through |
| 910 | vane actuating arm |
| 920 | vane stem |
| 940 | actuating ring |
| 950 | through-bolt |
| 970 | lead-through |
| 980 | nut |
| 990 | cotter pin |
| d1 | distance from the pivot axis to the |
| | centerline of the clamping surface |
| d2 | distance from the pivot axis to |
| | the central axis of the opening |
| d3 | distance from the opening to the |
| | centerline of the clamping surface |

What is claimed is:

1. A vane actuating arm for a turbomachine, the vane actuating arm comprising:
two legs pivotable relative to each other about a pivot axis between at least one open position and a closed position and forming a clamping device having at least one clamping surface on each of the legs, wherein in the closed position, a vane stem provided for varying the pitch of a stator vane of the turbomachine is frictionally holdable between the two legs via the two clamping surfaces, forming a clamping connection;
each of the legs having a fastening portion configured to be releasably, frictionally and/or form-fittingly connected to an actuating element of the turbomachine for controlling an angular position of the vane stem.

2. The vane actuating arm as recited in claim 1 wherein each of the fastening portions has an opening, the openings overlapping each other in the closed position such that a through-bolt connectable to an actuating element of the turbomachine for controlling an angular position of the vane stem is passable through the openings.

3. The vane actuating arm as recited in claim 1 wherein in the open position the vane actuating arm is attachable to the vane stem.

4. The vane actuating arm as recited in claim 1 wherein the pivot axis and the clamping surface are each disposed on one half of each leg, and the fastening portion is disposed on an opposite half of the respective leg.

5. The vane actuating arm as recited in claim 1 wherein the at least one clamping surface includes a first clamping surface on a first leg of the two legs and a second clamping surface on a second leg of the two legs, the first and second clamping surfaces facing each other and facing the pivot axis.

6. The vane actuating arm as recited in claim 1 wherein the vane actuating arm is formed as a single piece, and a pivotability of the vane actuating arm is achieved via at least one flexure bearing.

7. The vane actuating arm as recited in claim 1 wherein each fastening portion has an opening and in the closed position, a common central axis of the two openings is parallel to an axis of rotation of the vane stem.

8. The vane actuating arm as recited in claim 1 wherein in the closed position, a longitudinal direction of each leg is perpendicular to an axis of rotation of the vane stem.

9. The vane actuating arm as recited in claim 1 wherein for each leg, a distance from the pivot axis to the respective clamping surface is smaller than a distance from the pivot axis to a respective opening of the fastening portion.

10. The vane actuating arm as recited in claim 1 wherein for each leg a distance from the pivot axis to the respective clamping surface is smaller than a distance from the respective clamping surface to the respective opening of the fastening portion.

11. The vane actuating arm as recited in claim 1 wherein for each leg at least one of the clamping surfaces has a receiving element for form-fitting connection to a connecting device provided on the vane stem, and wherein in the closed position of the vane actuating arm, the receiving element of the at least one clamping surface is in engagement with the connecting device provided on the vane stem.

12. A turbomachine comprising the vane actuating arm as recited in claim 1.

13. A method for mounting the vane actuating arm as recited in claim 1, the method comprising:
placing, in the open position, the vane actuating arm on the vane stem of the stator vane, the stator vane being a variable stator vane, the vane stem provided for varying the pitch of the variable stator vane;
bringing the vane actuating arm into the closed position where the legs form a clamping connection via the two clamping surfaces, the clamping connection frictionally holding the vane stem between the two legs via the two clamping surface; and
connecting, in the closed position, the fastening portions releasably, frictionally or form-fittingly to an actuating element of the turbomachine for controlling an angular position of the vane stem.

14. The method as recited in claim 13 wherein the fastening portions are configured as openings, and wherein in the closed position, the openings overlap each other so as to receive therethrough a through-bolt to an actuating element of the turbomachine for controlling an angular position of the vane stem.
